(19) United States
(12) Patent Application Publication
(10) Pub. No.: US 2026/0323501 A1
(43) Pub. Date: Oct. 15, 2026

(54) METHOD AND DEVICE FOR CELL SELECTING

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/113,711

(22) PCT Filed: Sep. 28, 2022
(86) PCT No.: PCT/CN2022/122254

§ 371 Date: Mar. 20, 2025

(51) Int. Cl. H04W 48/20; H04W 64/00; H04W 88/08

(52) U.S. Cl. CPC H04W 48/20; H04W 64/006; H04W 88/08

(57) ABSTRACT

The embodiment of the invention discloses a method and device for cell selecting, which can be performed by systems such as Internet of Vehicles, and the method includes: determining whether a terminal device is a vehicle-mounted terminal device, and selecting a cell associated with an integrated access and return IAB node by the terminal device according to the determined whether the terminal device is the vehicle-mounted terminal device. By implementing the embodiment of the invention, the frequency priority is not considered during cell selection or cell reselection, the cell associated with the corresponding mobile IAB node is selected according to the mobile state of the terminal equipment, and the cell associated with the corresponding static IAB node is selected according to the static state of the terminal equipment, so that the number of times of cell reselection is effectively reduced.

### CROSS-REFERENCE TO RELATED APPLICATION

The present application is a U.S. National Phase of International Patent Application No. PCT/CN2022/122254 filed on Sep. 28, 2022. The contents of the above-cited application are hereby incorporated by reference for all purposes.

### BACKGROUND OF THE INVENTION

In R18 integrated access and backhaul (IAB), mobile IAB scenarios are supported. Mobile IAB focuses on scenarios in which a vehicle-mounted mobile IAB node provides 5G coverage/capability enhancement for a vehicle-mounted terminal and/or a non-vehicle-mounted terminal.

### SUMMARY OF THE INVENTION

Embodiments of the present disclosure provide a method and device for cell selecting.

According to a first aspect of the embodiments of the present disclosure, a method for cell selecting is provided. The method is performed by a terminal device and includes: determining whether the terminal device is a vehicle-mounted terminal device; and selecting, by the terminal device, according to a result of determining whether the terminal device is a vehicle-mounted terminal device, a cell associated with an integrated access and backhaul IAB node.

According to a second aspect of the embodiments of the present disclosure, a communication device is provided. The communication device includes: a transceiver; a memory; and a processor connected to the transceiver and the memory respectively, configured to control wireless signal transceiving of the transceiver by executing computer-executable instructions on the memory, and capable of implementing the method according to the first aspect.

According to a third aspect of the embodiments of the present disclosure, a non-temporary computer-readable storage medium is provided. The non-temporary computer storage medium stores computer-executable instructions which, when executed by a processor, implement the method according to the first aspect.

According to a fourth aspect of the embodiments of the present disclosure, a computer-readable storage medium is provided, the computer-readable storage medium for storing instructions used by the above terminal device. The instructions, when executed, cause the terminal device to perform the method according to the first aspect above.

According to a fifth aspect of the embodiments of the present disclosure, a computer program product is provided, the computer program product includes a computer program which, when run on a computer, causes the computer to perform the method according to the first aspect above.

According to a sixth aspect of the embodiments of the present disclosure, a chip system is provided. The chip system includes at least one processor and an interface, configured to support a terminal device to implement the functions involved in the first aspect, for example, determining or processing at least one of data and information involved in the method above. In a possible design, the chip system further includes a memory. The memory is configured to store a computer program and data necessary for the terminal device. The chip system may consist of chips, or include chips and other discrete devices.

According to a seventh aspect of the embodiments of the present disclosure, a computer program is provided. The computer program, when run on a computer, causes the computer to perform the method according to the first aspect above.

### BRIEF DESCRIPTION OF DRAWINGS

In order to describe the technical solutions in embodiments of the present application or in the background more clearly, the accompanying drawings to be used in the embodiments of the present application or in the background are described below.

FIG. 1 is a schematic structural diagram of a system for cell selecting, provided by an embodiment of the present disclosure.

FIG. 2 is a schematic flowchart of a method for cell selecting, provided by an embodiment of the present disclosure.

FIG. 3 is a schematic flowchart of a method for cell selecting, provided by another embodiment of the present disclosure.

FIG. 4 is a schematic flowchart of a method for cell selecting, provided by another embodiment of the present disclosure.

FIG. 5 is a schematic flowchart of a method for cell selecting, provided by another embodiment of the present disclosure.

FIG. 6 is a schematic flowchart of a method for cell selecting, provided by another embodiment of the present disclosure.

FIG. 7 is a schematic flowchart of a method for cell selecting, provided by another embodiment of the present disclosure.

FIG. 8 is a schematic flowchart of a method for cell selecting, provided by another embodiment of the present disclosure.

FIG. 9 is a schematic flowchart of a method for cell selecting, provided by another embodiment of the present disclosure.

FIG. 10 is a schematic flowchart of a method for cell selecting, provided by another embodiment of the present disclosure.

FIG. 11 is a schematic flowchart of a method for cell selecting, provided by another embodiment of the present disclosure.

FIG. 12 is a schematic flowchart of a method for cell selecting, provided by another embodiment of the present disclosure.

FIG. 13 is a schematic flowchart of a method for cell selecting, provided by another embodiment of the present disclosure.

FIG. 14 is a schematic flowchart of a method for determining whether a terminal device is a vehicle-mounted terminal device, provided by an embodiment of the present disclosure.

FIG. 15 is a schematic structural diagram of a device for cell selecting, provided by another embodiment of the present disclosure.

FIG. 16 is a schematic structural diagram of a device for cell selecting, provided by an embodiment of the present disclosure.

FIG. 17 is a schematic structural diagram of a device for cell selecting, provided by an embodiment of the present disclosure.

FIG. 18 is a schematic structural diagram of a device for cell selecting, provided by an embodiment of the present disclosure.

FIG. 19 is a schematic structural diagram of a device for cell selecting, provided by an embodiment of the present disclosure.

FIG. 20 is a schematic structural diagram of a device for cell selecting, provided by an embodiment of the present disclosure.

FIG. 21 is a schematic structural diagram of a device for cell selecting, provided by an embodiment of the present disclosure.

FIG. 22 is a schematic structural diagram of a device for cell selecting, provided by an embodiment of the present disclosure.

FIG. 23 is a schematic structural diagram of a terminal device, provided by an embodiment of the present disclosure.

### DETAILED DESCRIPTION OF THE INVENTION

Examples will be described in detail herein, examples of which are represented in the accompanying drawings. When the following description relates to the accompanying drawings, the same numerals in different accompanying drawings denote the same or similar elements, unless otherwise indicated. The implementations described in the following examples do not represent all the implementations consistent with the embodiments of the present disclosure. Rather, they are merely examples of devices and methods that are consistent with some aspects of the embodiments of the present disclosure and that are described in detail in the appended claims.

The embodiments of the present disclosure are described in detail below, and examples of the embodiments are illustrated in the accompanying drawings, where the same or similar reference numerals throughout denote Examples will be described in detail herein, examples of which are represented in the accompanying drawings. When the following description relates to the accompanying drawings, the same numerals in different accompanying drawings denote the same or similar elements, unless otherwise indicated. The implementations described in the following examples do not represent all the implementations consistent with the embodiments of the present disclosure. Rather, they are merely examples of devices and methods that are consistent with some aspects of the embodiments of the present disclosure and that are described in detail in the appended claims.

The terms used in the embodiments of the present disclosure are merely for the purpose of describing specific embodiments, and are not intended to limit the embodiments of the present disclosure. The singular forms “a”, “an” and “the” used in the embodiments of the present disclosure and the appended claims are also intended to include plural forms, unless the context clearly indicates otherwise. It is also to be understood that the term “and/or” used in this specification refers to and includes any or all possible combinations of one or more associated listed items.

It is to be understood that although the terms first, second, and third may be used in the embodiments of the present disclosure to describe various information, the information is not to be limited to these terms. These terms are merely used to distinguish the same type of information from each other. For example, without departing from the scope of the embodiments of the present disclosure, first information may also be referred to as second information, and similarly, second information may also be referred to as first information. Depending on the context, the term “if” as used herein may be interpreted as “when” or “while” or “in response to determining that”.

The embodiments of the present disclosure are described in detail below, and examples of the embodiments are illustrated in the accompanying drawings, where the same or similar reference numerals throughout denote the same or similar elements. The embodiments described below with reference to the accompanying drawings are illustrative and are intended to interpret the present disclosure but are not be construed as a limitation on the present disclosure.

In order to better understand a method for cell selecting disclosed in the embodiments of the present disclosure, a communication system to which the embodiments of the present disclosure are applicable is first described below. the same or similar elements. The embodiments described below with reference to the accompanying drawings are illustrative and are intended to interpret the present disclosure but are not be construed as a limitation on the present disclosure.

In order to better understand a method for cell selecting disclosed in the embodiments of the present disclosure, a communication system to which the embodiments of the present disclosure are applicable is first described below.

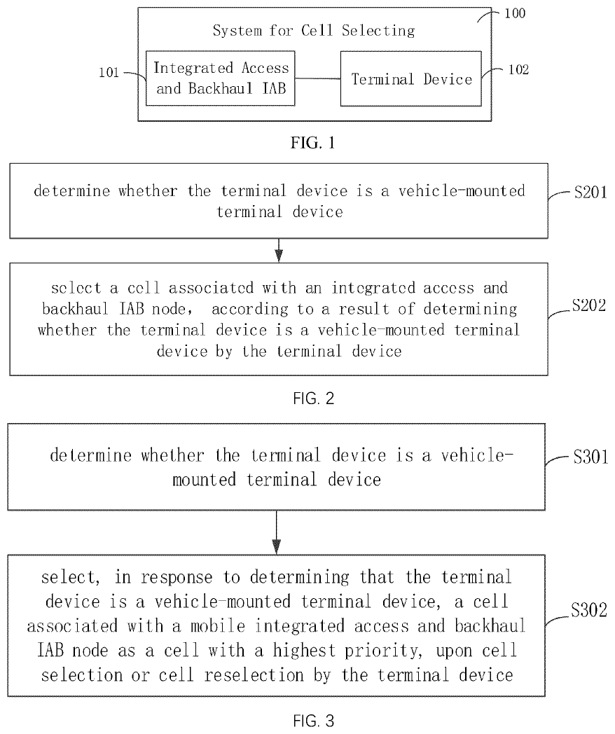

Referring to FIG. 1, FIG. 1 is a schematic diagram of an architecture of a communication system 100, provided by an embodiment of the present application.

In a system 100 for cell selecting, Integrated access and backhaul (IAB) 101 supports millimeter-wave base stations for wireless access and backhaul, which can effectively reduce the need for new fiber deployment when deploying dense networks, making wireless relay in NG-RAN possible. A relay node, referred to as an IAB-node, supports wireless access and backhaul via NR. A termination node of NR backhaul at network side is referred to as an IAB-donor and is a gNB with an additional IAB function. Backhaul may be performed via single or multiple hops. The number and form of the devices shown in FIG. 1 are merely for illustrative purpose and do not constitute a limitation on the embodiments of the present application. In actual application, two or more IAB-donors and three or more IAB-nodes may be included.

In R18 IAB, mobile IAB scenarios are supported. Mobile IAB focuses on scenarios in which a vehicle-mounted mobile IAB node provides 5G coverage/capability enhancement for a vehicle-mounted terminal and/or a non-vehicle-mounted terminal. A terminal device 102 served by the mobile IAB node may be categorized into a vehicle-mounted terminal device and a non-vehicle-mounted terminal. The vehicle-mounted terminal is a terminal device that moves together with the mobile IAB node, and the non-vehicle-mounted terminal is a terminal device that does not move with the mobile IAB node, which may be an R18 terminal device that supports a mobile IAB feature or an R17/R16 terminal device that does not support a mobile IAB feature. A peripheral terminal device may be a stationary terminal device or a mobile terminal device.

It is to be noted that the technical solutions of the embodiments of the present disclosure may be performed by various communication systems, for example, a long-term evolution (LTE) system, a 5th generation (5G) mobile communication system, a 5G new radio (NR) system, or other future new mobile communication systems, or the like.

The terminal device in the embodiments of the present disclosure includes a vehicle-mounted terminal device or non-vehicle-mounted terminal. The vehicle-mounted terminal device or non-vehicle-mounted terminal is an entity on a user side for receiving or transmitting a signal. The terminal device may also be referred to as a terminal, a mobile station (MS), a mobile terminal (MT), or the like. The terminal device may be a car with a communication function, a smart car, a mobile phone, a wearable device, a Pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of the present disclosure do not limit the specific technologies and the specific device forms used for the terminal device.

When cell selection and reselection are needed for a vehicle-mounted terminal device and a non-vehicle-mounted terminal device, different frequencies have different priorities. If merely frequency priority is considered, the vehicle-mounted terminal device may preferentially select a stationary IAB node, possibly resulting in frequently triggered cell reselection since the vehicle-mounted terminal keeps moving.

For the above problem, the embodiments of the present disclosure provide a method and device for cell selecting.

Referring to FIG. 2, FIG. 2 is a schematic flowchart of a method for cell selecting, provided by an embodiment of the present disclosure. As shown in FIG. 2, the method is performed by a terminal device, and may include, but be not limited to, the following steps.

Step S201: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself.

For example, as an implementation, the terminal device may belong to the same vehicle to which the mobile IAB node belongs and move together with the mobile IAB node. As another implementation, the terminal device may also belong to a vehicle different from a vehicle to which the mobile IAB node belongs; for example, the terminal device belongs to a vehicle A and the mobile IAB node belongs to a vehicle B, and the terminal device moves together with the vehicle A whereas the mobile IAB node moves together with the vehicle B; the vehicle A remains stationary relative to the vehicle B, that is, the terminal device remains stationary relative to the mobile IAB node. The terminal devices in the above two implementations are vehicle-mounted terminal devices.

The mobile IAB node may be an IAB node that moves together with the terminal device or an IAB node that remains stationary relative to the terminal device. For example, the mobile IAB node may be an IAB node belonging to the same vehicle to which the terminal device belongs, or the mobile IAB node may belong to a vehicle different from a vehicle to which the terminal device belongs, but the both need to remain stationary relative to each other. In this embodiment of the present application, whether the mobile IAB node and the terminal device are stationary relative to each other may be judged based on the movement speeds, the latitude and longitude positions, and the movement directions or the like. Or other implementations may also be used, and specifically are not limited in this embodiment of the present application.

Step S202: a cell associated with an integrated access and backhaul IAB node is selected by the terminal device, according to the determined whether the terminal device is a vehicle-mounted terminal device.

After it is determined that the terminal device is a vehicle-mounted terminal device, a cell associated with a mobile IAB node is preferentially selected. After it is determined that the terminal device is a non-vehicle-mounted terminal device, a cell associated with a stationary IAB node is preferentially selected.

In summary, in order to solve the problem of frequent cell selection or reselection by the vehicle-mounted terminal device, the terminal device selects, according to whether the terminal device is a vehicle-mounted terminal device, the cell associated with the corresponding IAB node according to a mobile state (for vehicle-mounted terminal device) of the terminal device and the cell associated with the corresponding IAB node according to a stationary state (for non-vehicle-mounted terminal device) of the terminal device upon cell selection and cell reselection, regardless of frequency priority, thereby effectively reducing the number of cell reselections.

An embodiment of the present disclosure provides another method for selecting a cell. FIG. 3 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 3, the method for cell selecting may include the following steps.

Step S301: whether the terminal device is a vehicle-mounted terminal device is determined.

Step S302: in response to determining that the terminal device is a vehicle-mounted terminal device, a cell associated with a mobile integrated access and backhaul IAB node as a cell with a highest priority is selected, upon cell selection or cell reselection by the terminal device.

When it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

As an implementation of this embodiment of the present application, there may be one or more cells associated with the mobile IAB node. When there is one cell associated with the mobile IAB node, the cell associated with the mobile IAB node is directly determined as the cell of the vehicle-mounted terminal device. When there are a plurality of cells associated with the mobile IAB node, a cell with relatively strong signal may be selected from the plurality of associated cells as the cell of the vehicle-mounted terminal device, or cell selection or reselection may be performed from the plurality of associated cells according to other preset rules. Specifically, the implementation of cell selection or reselection is not limited in this embodiment of the present application.

In summary, in order to solve the problem of frequent cell selection or reselection by the vehicle-mounted terminal device, the terminal device, when determining that the terminal device is a vehicle-mounted terminal device, selects, upon cell selection or cell reselection, the cell associated with the mobile IAB node as the cell with the highest priority, regardless of frequency priority, thereby effectively reducing the number of cell reselections.

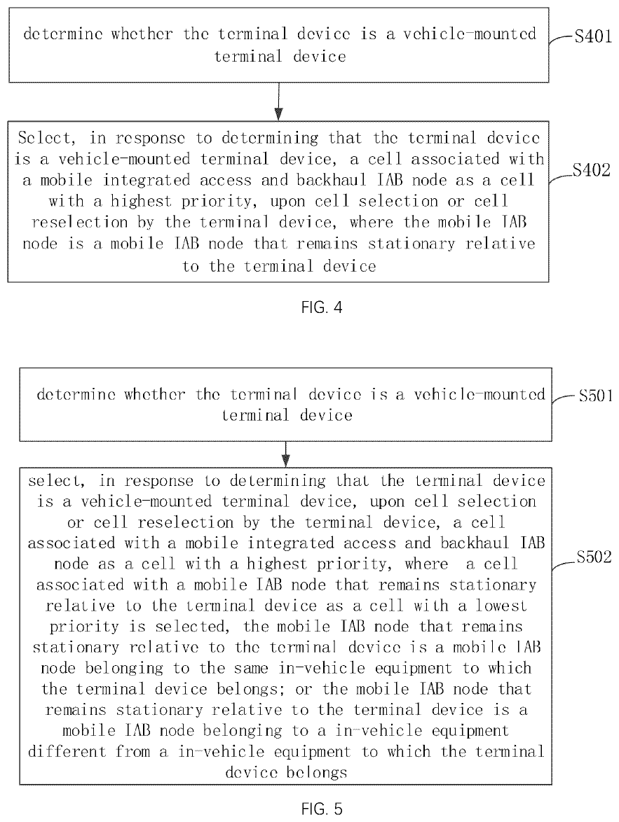

An embodiment of the present disclosure provides another method for selecting a cell. FIG. 4 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 4, the method for cell selecting may include the following steps.

Step S401: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S402: in response to determining that the terminal device is a vehicle-mounted terminal device, a cell associated with a mobile integrated access and backhaul IAB node as a cell with a highest priority is selected, upon cell selection or cell reselection by the terminal device, where the mobile IAB node is a mobile IAB node that remains stationary relative to the terminal device.

When it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

In a specific application process, whether the mobile IAB node remains stationary relative to the terminal device may be judged from the movement speeds, the latitude and longitude positions, and the movement directions between the both. If the movement speed, the latitude and longitude position, and the movement direction of the terminal device remain unchanged relative to the movement speed, the latitude and longitude position, and the movement direction of the mobile IAB node, it is determined that the mobile IAB node is a mobile IAB node that remains stationary relative to the terminal device. If the movement speed, the latitude and longitude position, and the movement direction of the terminal device cannot remain unchanged relative to the movement speed, the latitude and longitude position, and the movement direction of the mobile IAB node, it is determined that the mobile IAB node is a mobile IAB node that does not remain stationary relative to the terminal device. Specifically, the method for determining remaining stationary relative to each other is not limited in this embodiment of the present application.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node that remains stationary relative to the terminal device as the cell with the highest priority, regardless of frequency priority, thereby effectively reducing the number of cell reselections.

An embodiment of the present disclosure provides another method for selecting a cell. FIG. 5 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 5, the method for cell selecting may include the following steps.

Step S501: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S502: in response to determining that the terminal device is a vehicle-mounted terminal device, upon cell selection or cell reselection by the terminal device, a cell associated with a mobile integrated access and backhaul IAB node as a cell with a highest priority is selected, where a cell associated with a mobile IAB node that remains stationary relative to the terminal device as a cell with a lowest priority is selected, the mobile IAB node that remains stationary relative to the terminal device is a mobile IAB node belonging to the same vehicle to which the terminal device belongs; or the mobile IAB node that remains stationary relative to the terminal device is a mobile IAB node belonging to a vehicle different from a vehicle to which the terminal device belongs.

After it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

The mobile IAB node that remains stationary relative to the terminal device includes, but is not limited to, the following two application scenarios. Scenario I: the mobile IAB node belongs to the same vehicle to which the terminal device belongs, and the mobile IAB node moves together with the terminal device; for example, the terminal device belongs to a vehicle A and the mobile IAB node belongs to the vehicle A, and the terminal device and the mobile IAB node move together in synchronization with the movement of the vehicle A. Scenario II: the mobile IAB node may also belong to a vehicle different from a vehicle to which the terminal device belongs; for example, the terminal device belongs to a vehicle A and the mobile IAB node belongs to a vehicle B, and the terminal device moves together with the vehicle A whereas the mobile IAB node moves together with the vehicle B; the vehicle A remains stationary relative to the vehicle B, that is, the terminal device remains stationary relative to the mobile IAB node.

In a specific application process, whether the mobile IAB node remains stationary relative to the terminal device may be judged from the movement speeds, the latitude and longitude positions, and the movement directions between the both. When the movement speeds, the latitude and longitude positions, and the movement directions of the both are consistent, it may be determined that the both remain stationary relative to each other. Specifically, the method for determining remaining stationary relative to each other is not limited in this embodiment of the present application.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node that remains stationary relative to the terminal device as the cell with the highest priority, regardless of frequency priority, thereby effectively reducing the number of cell reselections.

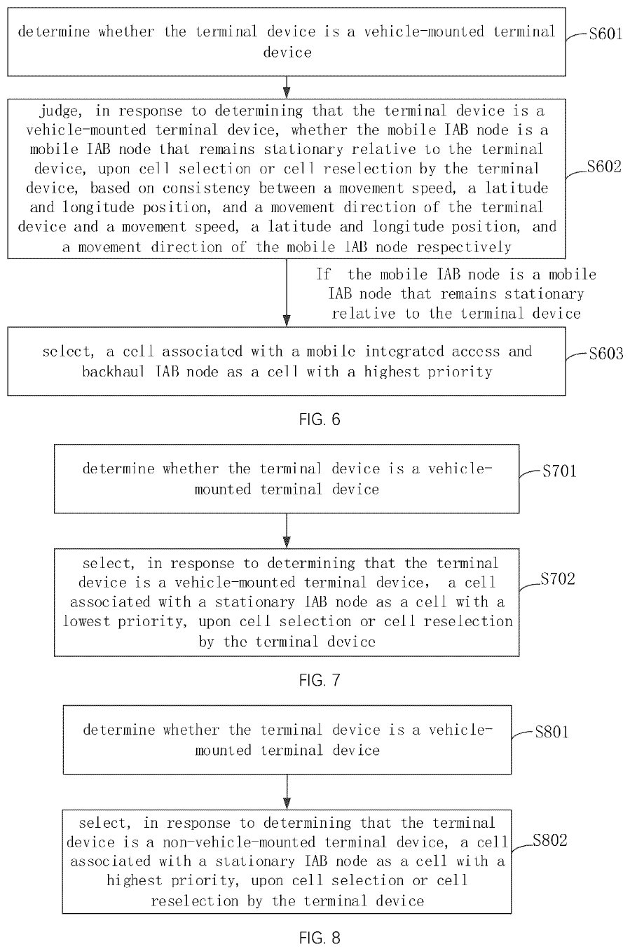

An embodiment of the present disclosure provides another method for selecting a cell. FIG. 6 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 6, the method for cell selecting may include the following steps.

Step S601: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S602: in response to determining that the terminal device is a vehicle-mounted terminal device, whether the mobile IAB node is a mobile IAB node that remains stationary relative to the terminal device is judged, upon cell selection or cell reselection by the terminal device, based on consistency between a movement speed, a latitude and longitude position, and a movement direction of the terminal device and a movement speed, a latitude and longitude position, and a movement direction of the mobile IAB node respectively.

If the movement speed, the latitude and longitude position, and the movement direction of the terminal device are the same as the movement speed, the latitude and longitude position, and the movement direction of the mobile IAB node respectively, it is determined that the mobile IAB node is a mobile IAB node that remains stationary relative to the terminal device. If at least one of the movement speed, the latitude and longitude position, and the movement direction of the terminal device is different from the movement speed, the latitude and longitude position, and the movement direction of the mobile IAB node respectively, it is determined that the mobile IAB node is a mobile IAB node that does not remain stationary relative to the terminal device.

Step S603: if the mobile IAB node is a mobile IAB node that remains stationary relative to the terminal device, a cell associated with a mobile integrated access and backhaul IAB node as a cell with a highest priority is selected.

After it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node that remains stationary relative to the terminal device as the cell with the highest priority, regardless of frequency priority, thereby effectively reducing the number of triggered cell reselections.

An embodiment of the present disclosure provides another method for selecting a cell. FIG. 7 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 7, the method for cell selecting may include the following steps.

Step S701: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S702: in response to determining that the terminal device is a vehicle-mounted terminal device, a cell associated with a stationary IAB node as a cell with a lowest priority is selected, upon cell selection or cell reselection by the terminal device.

If the movement speed, the latitude and longitude position, and the movement direction of the terminal device are consistent with the movement speed, the latitude and longitude position, and the movement direction of the mobile IAB node respectively, it is determined that the terminal device is a vehicle-mounted terminal device.

For example, the mobile IAB node belongs to the same vehicle to which the terminal device belongs, and the mobile IAB node moves together with the terminal device; for example, the terminal device belongs to a vehicle A and the mobile IAB node belongs to the vehicle A, and the terminal device and the mobile IAB node move together in synchronization with the movement of the vehicle A. Scenario II: the mobile IAB node may also belong to a vehicle different from a vehicle to which the terminal device belongs; for example, the terminal device belongs to a vehicle A and the mobile IAB node belongs to a vehicle B, and the terminal device moves together with the vehicle A whereas the mobile IAB node moves together with the vehicle B; the vehicle A remains stationary relative to vehicle B, that is, the terminal device remains stationary relative to the mobile IAB node. The terminal devices in the above two implementations are vehicle-mounted terminal devices.

After it is determined that the terminal device is a vehicle-mounted terminal device, the cell associated with the stationary IAB node is selected, upon cell selection or cell reselection by the terminal device, as the cell with the lowest priority. That is, the vehicle-mounted terminal device in the mobile state selects the cell associated with the stationary IAB node as the cell with the lowest priority, which can effectively reduce the number of triggered cell reselections.

In summary, in order to solve the problem of frequent cell selection or reselection by the vehicle-mounted terminal device, after the terminal device determines that the terminal device is a vehicle-mounted terminal device, the vehicle-mounted terminal device in the mobile state selects, upon cell selection or cell reselection, the cell associated with the stationary IAB node as the cell with the lowest priority, regardless of frequency priority, thereby effectively reducing the number of triggered cell reselections.

An embodiment of the present disclosure provides another method for selecting a cell. FIG. 8 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 8, the method for cell selecting may include the following steps.

Step S801: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S802: in response to determining that the terminal device is a non-vehicle-mounted terminal device, a cell associated with a stationary IAB node as a cell with a highest priority is selected, upon cell selection or cell reselection by the terminal device.

If at least one of the movement speed, the latitude and longitude position, and the movement direction of the terminal device is inconsistent with the movement speed, the latitude and longitude position, and the movement direction of the mobile IAB node respectively, it is determined that the terminal device is a non-vehicle-mounted terminal device.

For ease of understanding, for example, the terminal device is currently in the stationary state whereas the mobile IAB node is moving together with the vehicle; in this case, it may be determined that the terminal device is a non-vehicle-mounted terminal device. Or the terminal device belongs to a vehicle A and the mobile IAB node belongs to a vehicle B, but at least one of the movement speed, the latitude and longitude position, and the movement direction of the terminal device is different from the movement speed, the latitude and longitude position, and the movement direction of the mobile IAB node; it may be determined that the terminal device is a non-vehicle-mounted terminal device. Or the non-vehicle-mounted terminal is a terminal other than a terminal belonging to a vehicle-mounted terminal. Specifically, the method for determining the non-vehicle-mounted terminal and the scenario in which the non-vehicle-mounted terminal is located are not limited in this embodiment of the present application.

The terminal, after determining that the terminal device is a non-vehicle-mounted terminal device, selects, upon cell selection or cell reselection by the terminal device, the cell associated with the stationary IAB node as the cell with the highest priority, regardless of frequency priority. That is, the non-vehicle-mounted terminal device in the stationary state selects the cell associated with the stationary IAB node as the cell with the highest priority, which can effectively reduce the number of triggered cell reselections.

In summary, in order to solve the problem of frequent cell selection or reselection by the vehicle-mounted terminal device, the terminal device, after determining that the terminal device is a non-vehicle-mounted terminal device, selects, upon cell selection or cell reselection, the cell associated with the stationary IAB node as the cell with the highest priority, regardless of frequency priority, thereby effectively reducing the number of triggered cell reselections.

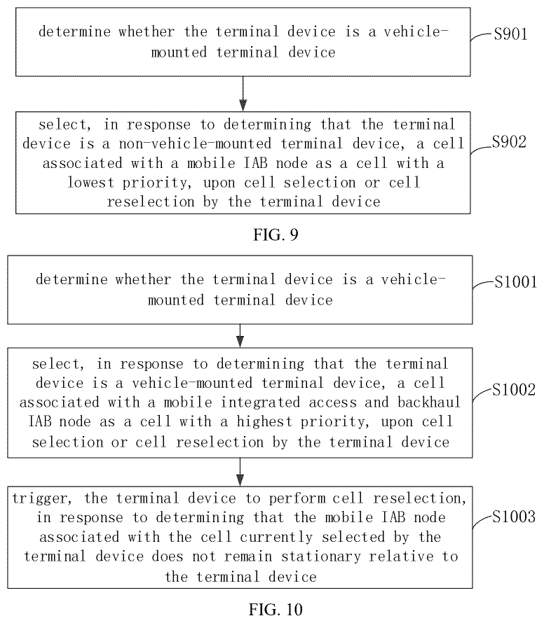

An embodiment of the present disclosure provides another method for selecting a cell. FIG. 9 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 9, the method for cell selecting may include the following steps.

Step S901: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S902: in response to determining that the terminal device is a non-vehicle-mounted terminal device, a cell associated with a mobile IAB node as a cell with a lowest priority is selected, upon cell selection or cell reselection by the terminal device.

If at least one of the movement speed, the latitude and longitude position, and the movement direction of the terminal device is inconsistent with the movement speed, the latitude and longitude position, and the movement direction of the mobile IAB node respectively, it is determined that the terminal device is a non-vehicle-mounted terminal device.

For ease of understanding, for example, the terminal device is currently in the stationary state whereas the mobile IAB node is moving together with the vehicle; in this case, it may be determined that the terminal device is a non-vehicle-mounted terminal device. Alternatively, if the terminal device belongs to a vehicle A and the mobile IAB node belongs to a vehicle B, but at least one of the movement speed, the latitude and longitude position, and the movement direction of the terminal device is different from the movement speed, the latitude and longitude position, and the movement direction of the mobile IAB node; it may be determined that the terminal device is a non-vehicle-mounted terminal device. Alternatively, the non-vehicle-mounted terminal is a terminal other than a terminal belonging to a vehicle-mounted terminal. Specifically, the method for determining the non-vehicle-mounted terminal and the scenario in which the non-vehicle-mounted terminal is located are not limited in this embodiment of the present application.

The terminal, after determining that the terminal device is a non-vehicle-mounted terminal device, selects or reselects, upon cell selection or cell reselection by the terminal device, the cell associated with the mobile IAB node as the cell with the lowest priority, regardless of frequency priority. That is, the non-vehicle-mounted terminal device in the stationary state selects the cell associated with the mobile IAB node as the cell with the lowest priority, which can effectively reduce the number of triggered cell reselections.

In summary, in order to solve the problem of frequent cell selection or reselection by the vehicle-mounted terminal device, the terminal device, after determining that the terminal device is a non-vehicle-mounted terminal device, selects, during cell selection and/or reselection, the cell associated with the mobile IAB node as the cell with the lowest priority, regardless of frequency priority, thereby effectively reducing the number of triggered cell reselections.

An embodiment of the present disclosure provides another method for selecting a cell. FIG. 10 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 10, the method for cell selecting may include the following steps.

Step S1001: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S1002: in response to determining that the terminal device is a vehicle-mounted terminal device, a cell associated with a mobile integrated access and backhaul IAB node as a cell with a highest priority is selected, upon cell selection or cell reselection by the terminal device.

After it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

Step S1003: the terminal device to perform cell reselection is triggered, in response to determining that the mobile IAB node associated with the cell currently selected by the terminal device does not remain stationary relative to the terminal device.

If the IAB node associated with the cell in which the terminal device resides or that is selected by the terminal device is a mobile IAB node on a neighboring vehicle, when the neighboring vehicle changes the direction/speed of travel, or the like, the terminal device determines that the mobile IAB node associated with the cell in which the terminal device currently resides is not stationary relative to the terminal device itself; in this case, there is a need to trigger cell reselection, and the terminal device reselects a cell associated with the mobile IAB node that remains stationary relative to the terminal device.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node as the cell with the highest priority, and triggers the terminal device to perform cell reselection when determining that the mobile IAB node associated with the cell currently selected by the terminal device does not remain stationary relative to the terminal device.

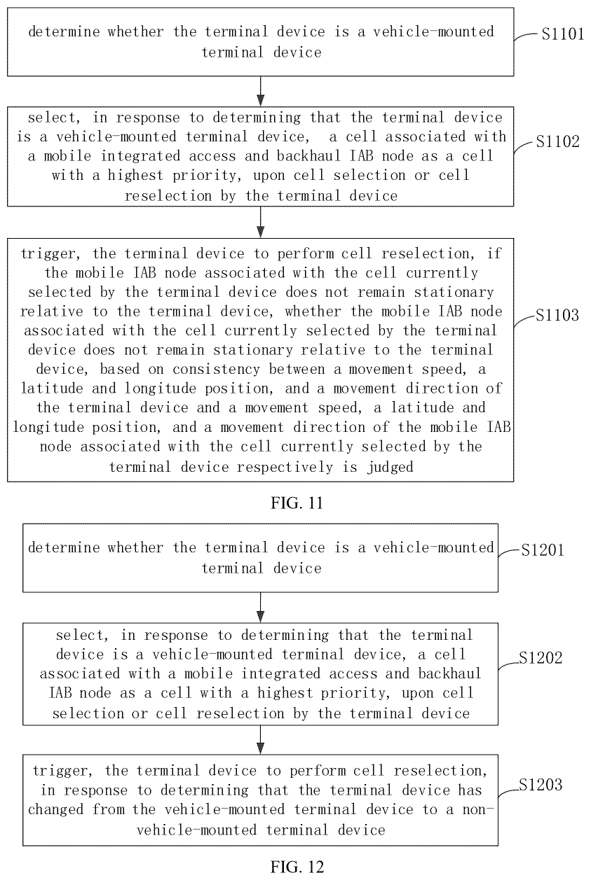

An embodiment of the present disclosure provides another method for selecting a cell. FIG. 11 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 11, the method for cell selecting may include the following steps.

Step S1101: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S1102: in response to determining that the terminal device is a vehicle-mounted terminal device, a cell associated with a mobile integrated access and backhaul IAB node as a cell with a highest priority is selected, upon cell selection or cell reselection by the terminal device.

After it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

Step S1103: the terminal device to perform cell reselection is triggered, if the mobile IAB node associated with the cell currently selected by the terminal device does not remain stationary relative to the terminal device, whether the mobile IAB node associated with the cell currently selected by the terminal device does not remain stationary relative to the terminal device, based on consistency between a movement speed, a latitude and longitude position, and a movement direction of the terminal device and a movement speed, a latitude and longitude position, and a movement direction of the mobile IAB node associated with the cell currently selected by the terminal device respectively is judged.

After the terminal device selects one cell, the terminal device needs to determine, in real time or within a preset time interval, whether a mobile IAB node associated with the cell currently selected by the terminal device does not remain stationary relative to the terminal device, which is intended to determine the consistency between the movement of the terminal device and the movement of the associated mobile IAB node.

As an achievable implementation of this embodiment of the present application, the terminal device judges whether the mobile IAB node associated with the cell currently selected by the terminal device does not remain relatively stationary relative to the terminal device, based on the consistency between the movement speed, the latitude and longitude position, and the movement direction of the terminal device and the movement speed, the latitude and longitude position, and the movement direction of the mobile IAB node associated with the cell currently selected by the terminal device respectively. If it is determined that at least one of the movement speed, the latitude and longitude position, and the movement direction of the terminal device is different from the movement speed, the latitude and longitude position, and the movement direction of the mobile IAB node associated with the cell currently selected by the terminal device respectively, it is determined that the mobile IAB node associated with the cell currently selected by the terminal device does not remain stationary relative to the terminal device.

The terminal device determines that the mobile IAB node associated with the cell in which the terminal device currently resides is not stationary relative to the terminal device itself; in this case, there is a need to trigger cell reselection, and the terminal device reselects a cell associated with the mobile IAB node that remains stationary relative to the terminal device.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node as the cell with the highest priority, and triggers the terminal device to perform cell reselection when determining that the mobile IAB node associated with the cell currently selected by the terminal device does not remain stationary relative to the terminal device.

An embodiment of the present disclosure provides another method for selecting a cell. FIG. 12 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 12, the method for cell selecting may include the following steps.

Step S1201: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S1202: in response to determining that the terminal device is a vehicle-mounted terminal device, a cell associated with a mobile integrated access and backhaul IAB node as a cell with a highest priority is select, upon cell selection or cell reselection by the terminal device.

After it is determined that the terminal device is a vehicle-mounted terminal device, the cell associated with the mobile IAB node is selected, upon cell selection or cell reselection by the terminal device, as the cell with the highest priority. In actual application, the cell associated with the mobile IAB node has been pre-configured, and once it is determined that the terminal device is a vehicle-mounted terminal device, the cell associated with the mobile IAB node is preferentially selected upon cell selection or reselection.

Step S1203: the terminal device to perform cell reselection is triggered, in response to determining that the terminal device has changed from the vehicle-mounted terminal device to a non-vehicle-mounted terminal device.

If the terminal device is taken off board the vehicle, the terminal device determines, according to the movement speeds, the latitude and longitude positions, the movement directions, and the like of the terminal device itself and the mobile IAB node associated with the cell in which the terminal device currently resides, that the terminal device itself has changed from the vehicle-mounted terminal to the non-vehicle-mounted terminal, and the terminal device triggers cell reselection.

The terminal device, when having changed from the vehicle-mounted terminal device to the non-vehicle-mounted terminal device, upon cell reselection, the cell associated with the stationary IAB node as the cell with the highest priority and the cell associated with the mobile IAB node as the cell with the lowest priority is selected.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node as the cell with the highest priority, and triggers the terminal device to perform cell reselection when determining that the terminal device has changed from the vehicle-mounted terminal device to the non-vehicle-mounted terminal device.

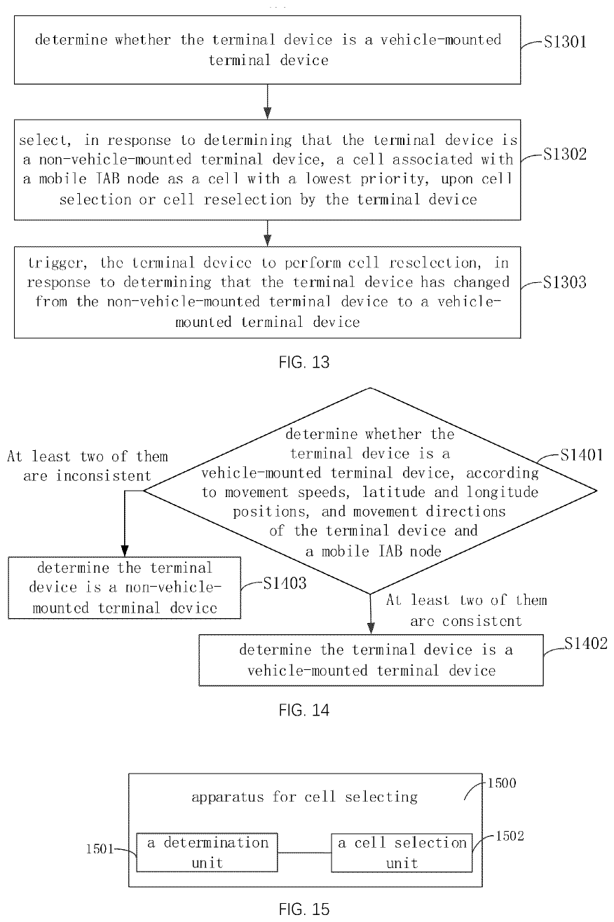

An embodiment of the present disclosure provides another method for selecting a cell. FIG. 13 is a schematic flowchart of another method for selecting a cell, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 13, the method for cell selecting may include the following steps.

Step S1301: whether the terminal device is a vehicle-mounted terminal device is determined.

The vehicle-mounted terminal device in this embodiment of the present application refers to a terminal device that moves together with a mobile IAB node. In a specific implementation process, whether the terminal device is a vehicle-mounted terminal device is determined by the terminal device itself, according to movement speeds, movement directions, or latitude and longitude positions of the terminal device itself and the mobile IAB node.

Step S1302: in response to determining that the terminal device is a non-vehicle-mounted terminal device, a cell associated with a mobile IAB node as a cell with a lowest priority is selected, upon cell selection or cell reselection by the terminal device.

In response to determining that the terminal device is a non-vehicle-mounted terminal device, the cell associated with the mobile IAB node is selected, upon cell selection or cell reselection by the terminal device, as the cell with the lowest priority.

Step S1303: the terminal device to perform cell reselection is triggered, in response to determining that the terminal device has changed from the non-vehicle-mounted terminal device to a vehicle-mounted terminal device.

If the terminal device is taken on board the vehicle, the terminal device determines, according to the movement speeds, the latitude and longitude positions, the movement directions, and the like of the terminal device itself and the mobile IAB node associated with the cell in which the terminal device currently resides, that the terminal device has changed from the non-vehicle-mounted terminal to the vehicle-mounted terminal, and the terminal device triggers cell reselection. When the terminal device performs cell reselection, the cell associated with the mobile IAB node is selected as the cell with the highest priority, and the cell associated with the stationary IAB node is selected as the cell with the lowest priority.

In summary, in order to solve the problem of frequent cell selection or reselection by a vehicle-mounted terminal device, the terminal device, after determining that the terminal device is a vehicle-mounted terminal device, selects, upon cell selection or cell reselection, the cell associated with the mobile IAB node as the cell with the highest priority, and triggers the terminal device to perform cell reselection when determining that the terminal device has changed from the non-vehicle-mounted terminal device to the vehicle-mounted terminal device.

An embodiment of the present disclosure provides another method for selecting a cell. FIG. 14 is a schematic flowchart of a method for determining whether a terminal device is a vehicle-mounted terminal device, provided by an embodiment of the present disclosure. The method may be performed by a terminal device. The method for cell selecting may be performed alone, or performed in combination with any embodiment in the present disclosure or any possible implementation in the embodiment, or performed in combination with any technical solution in the related art.

As shown in FIG. 14, the method for determining whether the terminal device is the vehicle-mounted terminal device may include the following steps.

Step S1401: whether the terminal device is a vehicle-mounted terminal device is determined, according to movement speeds, latitude and longitude positions, and movement directions of the terminal device and a mobile IAB node.

As an implementation of this embodiment of the present application, when respectively obtaining of the movement speeds, the latitude and longitude positions, and the movement directions of the terminal device and the mobile IAB node, the movement speeds, the latitude and longitude positions, and the movement directions may be obtained by directly invoking of a built-in function within the terminal device or the mobile IAB node. As another implementation of this embodiment of the present application, the movement speeds, the latitude and longitude positions, and the movement directions of the terminal device and the mobile IAB node may be respectively obtained by a predetermined sensor. The implementation of obtaining the movement speeds, the latitude and longitude positions, and the movement directions of the terminal device and the mobile IAB node is not specifically limited in this embodiment of the present application.

Step S1402: the terminal device is a vehicle-mounted terminal device is determined, if at least two of the movement speed, the latitude and longitude position, and the movement direction of the terminal device are consistent with the movement speed, the latitude and longitude position, and the movement direction of the mobile IAB node.

In an example, it can be determined that the terminal device is a vehicle-mounted terminal device only if it is ensured that the movement speed, the latitude and longitude position, and the movement direction of the terminal device are all consistent with the movement speed, the latitude and longitude position, and the movement direction of the mobile IAB node. In another example, it can be determined that the terminal device is a vehicle-mounted terminal device only if it is ensured that at least two of the movement speed, the latitude and longitude position, and the movement direction of the terminal device are consistent with the movement speed, the latitude and longitude position, and the movement direction of the mobile IAB node. Other manners are not limited in this embodiment of the present application.

Step S1403: the terminal device is a non-vehicle-mounted terminal device is determined, if at least two of the movement speed, the latitude and longitude position, and the movement direction of the terminal device are inconsistent with the movement speed, the latitude and longitude position, and the movement direction of the mobile IAB node.

In an example, it is determined that the terminal device is a non-vehicle-mounted terminal device if at least one of the movement speed, the latitude and longitude position, and the movement direction of the terminal device is inconsistent with the movement speed, the latitude and longitude position, and the movement direction of the mobile IAB node. Or in another example, it is determined that the terminal device is a non-vehicle-mounted terminal device if at least two of the movement speed, the latitude and longitude position, and the movement direction of the terminal device are inconsistent with the movement speed, the latitude and longitude position, and the movement direction of the mobile IAB node. Other manners are not limited in this embodiment of the present application.

In summary, in order to solve the problem of frequent cell selection or reselection by the vehicle-mounted terminal device, the terminal device first determines, upon cell selection or cell reselection, the current mobile status (vehicle-mounted terminal device or non-vehicle-mounted terminal device) of the terminal device, and the terminal device, after determining that the terminal device is a vehicle-mounted terminal device, selects, upon cell selection or cell reselection, the cell associated with the mobile IAB node as the cell with the highest priority, and the terminal device, after determining that the terminal device is a non-vehicle-mounted terminal device, selects, upon cell selection or cell reselection, the cell associated with the mobile IAB node as the cell with the lowest priority, regardless of frequency priority, thereby effectively reducing the number of cell reselections.

The non-vehicle-mounted terminal device in this embodiment of the present application is a terminal device that supports a mobile IAB feature. For example, the non-vehicle-mounted terminal device refers to a terminal device that supports an R18 mobile IAB feature, excluding an R16/17 terminal device that does not support an R18 mobile feature.

Corresponding to the method for cell selecting provided by the embodiments of FIG. 2 to FIG. 14 above, the present disclosure further provides a device for cell selecting. Since the device for cell selecting provided by the embodiments of the present disclosure corresponds to the method for cell selecting provided by the embodiments of FIG. 2 to FIG. 14 above, the implementations of the method for cell selecting are also applicable to the device for cell selecting provided by the embodiments of the present disclosure, which is not described in detail in the embodiments of the present disclosure.

FIG. 15 is a schematic structural diagram of an apparatus 1500 for cell selecting, provided by an embodiment of the present disclosure. The apparatus 1500 is performed by a terminal device, and includes: a determination unit 1501 and a cell selection unit 1502.

The determination unit 1501 is configured to determine whether the terminal device is a vehicle-mounted terminal device.

The cell selection unit 1502 is configured to select, upon cell selection or cell reselection by the terminal device, a cell associated with a mobile integrated access and backhaul IAB node as a cell with a highest priority in response to determining that the terminal device is a vehicle-mounted terminal device.

In summary, in order to solve the problem of frequent cell selection or reselection by the vehicle-mounted terminal device, the terminal device, after determining that the terminal device is a vehicle-mounted terminal device, selects, upon cell selection or cell reselection, the cell associated with the mobile IAB node as the cell with the highest priority, regardless of frequency priority, thereby effectively reducing the number of cell reselections.

As a possible implementation of this embodiment of the present disclosure, the mobile IAB node is: a mobile IAB node that remains stationary relative to the terminal device.

As a possible implementation of this embodiment of the present disclosure, the mobile IAB node that remains stationary relative to the terminal device is a mobile IAB node belonging to the same vehicle to which the terminal device belongs; or the mobile IAB node that remains stationary relative to the terminal device is a mobile IAB node belonging to a vehicle different from a vehicle to which the terminal device belongs.

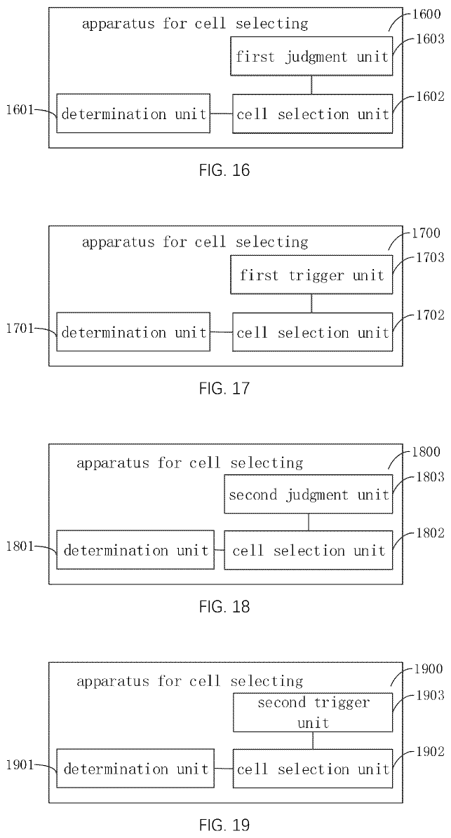

As a possible implementation of this embodiment of the present disclosure, as shown in FIG. 16, an apparatus 1600 for cell selecting includes: a determination unit 1601, a cell selection unit 1602, and a first judgment unit 1603. For the determination unit 1601 and the cell selection unit 1602, reference may be made to the detailed description of the determination unit 1501 and the cell selection unit 1502.

The first judgment unit 1603 is configured to judge whether the mobile IAB node is a mobile IAB node that remains stationary relative to the terminal device based on consistency between a movement speed, a latitude and longitude position, and a movement direction of the terminal device and a movement speed, a latitude and longitude position, and a movement direction of the mobile IAB node respectively.

As a possible implementation of this embodiment of the present disclosure, the apparatus 1600 further includes: the cell selection unit 1602 further configured to select, upon cell selection or cell reselection by the terminal device, a cell associated with a stationary IAB node as a cell with a lowest priority in response to determining that the terminal device is a vehicle-mounted terminal device.

As a possible implementation of this embodiment of the present disclosure, the cell selection unit 1602 further configured to select, upon cell selection or cell reselection by the terminal device, a cell associated with a stationary IAB node as a cell with a highest priority in response to determining that the terminal device is a non-vehicle-mounted terminal device.

As a possible implementation of this embodiment of the present disclosure, the cell selection unit 1602 further configured to select, upon cell selection or cell reselection by the terminal device, a cell associated with a mobile IAB node as a cell with a lowest priority in response to determining that the terminal device is a non-vehicle-mounted terminal device.

As a possible implementation of this embodiment of the present disclosure, as shown in FIG. 17, an apparatus 1700 for cell selecting includes: a determination unit 1701, a cell selection unit 1702, and a first trigger unit 1703. For the determination unit 1701 and the cell selection unit 1702, reference may be made to the detailed description of the determination unit 1501 and the cell selection unit 1502.

The first trigger unit 1703 is configured to trigger the terminal device to perform cell reselection, in response to determining that the mobile IAB node associated with the cell currently selected by the terminal device does not remain stationary relative to the terminal device.

As a possible implementation of this embodiment of the present disclosure, as shown in FIG. 18, an apparatus 1800 for cell selecting includes: a determination unit 1801, a cell selection unit 1802, and a second judgment unit 1803. For the determination unit 1801 and the cell selection unit 1802, reference may be made to the detailed description of the determination unit 1501 and the cell selection unit 1502.

The second judgment unit 1803 is configured to judge whether the mobile IAB node associated with the cell currently selected by the terminal device does not remain stationary relative to the terminal device, based on consistency between a movement speed, a latitude and longitude position, and a movement direction of the terminal device and a movement speed, a latitude and longitude position, and a movement direction of the mobile IAB node associated with the cell currently selected by the terminal device respectively.

As a possible implementation of this embodiment of the present disclosure, as shown in FIG. 19, an apparatus 1900 for cell selecting includes: a determination unit 1901, a cell selection unit 1902, and a second trigger unit 1903. For the determination unit 1901 and the cell selection unit 1902, reference may be made to the detailed description of the determination unit 1501 and the cell selection unit 1502.

The second trigger unit 1903 is configured to trigger the terminal device to perform cell reselection, in response to determining that the terminal device has changed from the vehicle-mounted terminal device to a non-vehicle-mounted terminal device.

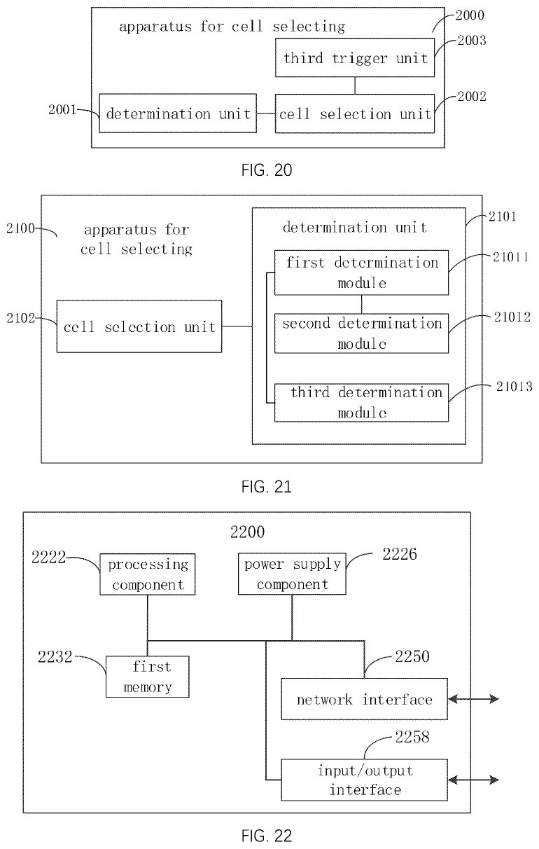

As a possible implementation of this embodiment of the present disclosure, as shown in FIG. 20, an apparatus 2000 for cell selecting includes: a determination unit 2001, a cell selection unit 2002, and a third trigger unit 2003. For the determination unit 2001 and the cell selection unit 2002, reference may be made to the detailed description of the determination unit 1501 and the cell selection unit 1502.

The third trigger unit 2003 is configured to trigger the terminal device to perform cell reselection, in response to determining that the terminal device has changed from the non-vehicle-mounted terminal device to a vehicle-mounted terminal device.

As a possible implementation of this embodiment of the present disclosure, as shown in FIG. 21, an apparatus 2100 for cell selecting includes: a determination unit 2101 and a cell selection unit 2102. For the cell selection unit 2102, reference may be made to the detailed description of the cell selection unit 1502.

The determination unit 2101 includes a first determination module 21011, a second determination module 21012, and a third determination module 21013.

The first determination module 21011 is configured to determine, according to the movement speeds, the latitude and longitude positions, and the movement directions of the terminal device and a mobile IAB node, whether the terminal device is a vehicle-mounted terminal device.

The second determination module 21012 is configured to determine that the terminal device is a vehicle-mounted terminal device when at least two of the movement speed, the latitude and longitude position, and the movement direction of the terminal device are consistent with the movement speed, the latitude and longitude position, and the movement direction of the mobile IAB node.

The third determination module 21013 is configured to determine that the terminal device is a non-vehicle-mounted terminal device when at least two of the movement speed, the latitude and longitude position, and the movement direction of the terminal device are inconsistent with the movement speed, the latitude and longitude position, and the movement direction of the mobile IAB node.

As a possible implementation of this embodiment of the present disclosure, the non-vehicle-mounted terminal device is a terminal device that supports a mobile IAB feature.

In order to implement the above embodiments, the present disclosure further provides a device for cell selecting. The device includes a processor and a memory, where a computer program is stored in the memory, and the processor executes the computer program stored in the memory to cause the device to perform the method described in FIG. 2 to FIG. 14.

In order to implement the above embodiments, the present disclosure further provides another device for cell selecting. The device includes: a processor and an interface circuit; the interface circuit is configured to receive code instructions and transmit the code instructions to the processor; and the processor is configured to run the code instructions to perform the method described in FIG. 2 to FIG. 14.

In order to implement the above embodiments, the present disclosure provides a computer-readable storage medium configured to store instructions. The instructions, when executed, cause the method described in FIG. 2 to FIG. 14 to be implemented.

In the above embodiments provided in the present application, the method provided in the embodiments of the present disclosure is described from the perspective of the terminal device. In order to implement the functions in the method provided in the above embodiments of the present disclosure, the terminal device may include a hardware structure, a software module, and implement the above functions in a form of a hardware structure, a software module, or a hardware structure plus a software module. One of the above functions may be performed in a manner of a hardware structure, a software module, or a hardware structure plus a software module.

Referring to FIG. 22, FIG. 22 is a schematic structural diagram of a device for cell selecting, provided by an embodiment of the present disclosure. Referring to FIG. 22, a network device 2200 includes a processing component 2222, which further includes at least one first processor, and a memory resource represented by a first memory 2232 for storing instructions executable by the processing component 2222, for example, an application program. The application program stored in the first memory 2232 may include one or more modules each corresponding to a set of instructions. In addition, the processing component 2222 is configured to execute the instructions to implement any foregoing method of the above method that is performed by the network device, for example, the method described in the embodiments in FIG. 2 to FIG. 14.

The network device 2200 may further include a power supply component 2226 configured to perform power management of the network device 2200, a wired or wireless network interface 2250 configured to connect the network device 2200 to a network, and an input/output (I/O) interface 2258. The network device 2200 may operate an operating system stored in the first memory 2232, for example, Window Server™, Mac OS X™, Unix™, Linux™, FreeBSD™, or the like.

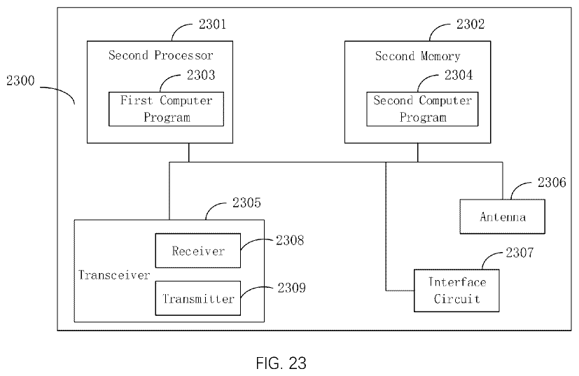

FIG. 23 is a block diagram of a device for cell selecting, provide by an embodiment of the present disclosure.

In FIG. 23, the device 2300 for cell selecting may be a terminal device, or a chip, chip system, or processor, or the like that supports a network device to implement the method, or a chip, chip system, or processor, or the like that supports a terminal device to implement the method. The device may be configured to implement the methods described in the method embodiments. For details, reference may be made to the method embodiments.

The device 2300 for cell selecting may include one or more second processors 2301. The second processor 2301 may be a general-purpose processor or a special-purpose processor, for example, a base band processor or a central processing unit. The base band processor may be configured to process a communication protocol and communication data. The central processing unit may be configured to: control the device for cell selecting (e.g., a base station, a base band chip, a terminal device, a terminal device chip, a DU or CU, or the like), execute a computer program, and process data of the computer program.

Optionally, the device 2300 for cell selecting may further include one or more second memories 2302 on which a second computer program 2304 may be stored. The second processor 2301 executes the second computer program 2304 to cause the device 2300 for cell selecting to perform the method described in the above method embodiments. Optionally, the second memory 2302 may further store data. The device 2300 for cell selecting and the second memory 2302 may be arranged separately or integrated together.

Optionally, the device 2300 for cell selecting may further include a transceiver 2305 and an antenna 2306. The transceiver 2305 may be referred to as a transceiver unit, a transceiver machine, or a communication device transceiver circuit, or the like to implement a transceiver function. The transceiver 2305 may include a receiver 2308 and a transmitter 2309. The receiver 2308 may be referred to as a receiver machine, or a receiver circuit, or the like to implement a receiving function. The transmitter 2309 may be referred to as a transmitter machine, or a transmitter circuit, or the like to implement a transmitting function.

Optionally, the device 2300 for cell selecting may further include one or more interface circuits 2307. The interface circuit 2307 is configured to receive code instructions and transmit the code instructions to the second processor 2301. The second processor 2301 runs the code instructions to cause the device 2300 for cell selecting to perform the method described in the method embodiments.

The device 2300 for cell selecting is a terminal device, where the second processor 2301 is configured to execute FIG. 2 to FIG. 12, etc.

In an implementation, the second processor 2301 may include a transceiver configured to implement receiving and transmitting functions. For example, the transceiver may be a transceiver circuit, or interface, or interface circuit. The transceiver circuit, interface, or interface circuit configured to implement the receiving and transmitting functions may be separate or integrated together. The transceiver circuit, interface or interface circuit may be configured to read and write code/data, or the transceiver circuit, interface, or interface circuit may be configured to transmit or transfer a signal.

In an implementation, the second processor 2301 may store a first computer program 2303. The first computer program 2303, when run on the second processor 2301, may cause the device 2300 for cell selecting to perform the method described in the above method embodiments. The first computer program 2303 may be solidified in the second processor 2301; in this case, the second processor 2301 may be implemented by hardware.

In an implementation, the device 2300 for cell selecting may include a circuit. The circuit may implement the transmitting, or receiving, or communicating function in the foregoing method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, or the like. The processor and the transceiver may also be manufactured using various IC process technologies, for example, complementary metal oxide semiconductor (CMOS), n-Metal oxide semiconductor (NMOS), positive channel metal oxide semiconductor (PMOS), bipolar junction transistor (BJT), bipolar CMOS (BiCMOS), silicon germanium (SiGe), and gallium arsenide (GaAs).

The device terminal device for cell selecting described in the embodiments, but the scope of the device for cell selecting described in the present disclosure is not limited to this, and the structure of the device for cell selecting may not be limited by FIG. 23. The device for cell selecting may be a stand-alone device or may be part of a larger device. For example, the device for cell selecting may be: (1) a stand-alone integrated circuit IC, or a chip, or a chip system or subsystem; (2) a set having one or more ICs, where optionally, the IC set may also include a storage component configured to store data and a computer program; (3) an ASIC, for example, a modulator/demodulator (Modem); (4) a module that can be embedded in other devices; (5) a receiver machine, terminal device, intelligent terminal device, cellular phone, wireless device, handheld device, mobile unit, vehicle-mounted device, network device, cloud device, artificial intelligence device, or the like; or (6) others and so on.

The present disclosure further provides a non-transitory computer-readable storage medium on which instructions are stored. The instructions, when executed by a computer, implement the functions of any one of the method embodiments.

The present disclosure further provides a computer program product. The computer program product, when executed by a computer, implements the functions of any one of the method embodiments.

Those skilled in the art may also understand that the various illustrative logical blocks and steps listed in the embodiments of the present disclosure may be implemented by electronic hardware, computer software, or a combination of electronic hardware and computer software. Whether such functions are implemented by hardware or software depends on the specific application and design requirements of the whole system. Those skilled in the art may implement the described functions for each specific application by using various methods, but such implementation is not to be understood as exceeding the protection scope of the embodiments of the present disclosure.

In the embodiments, it may be fully or partially implemented by software, hardware, firmware, or any combination thereof. When implemented using software, it may be fully or partially implemented in the form of a computer program product. The computer program product includes one or more computer programs. When the computer program is loaded and executed on the computer, all or part of the processes or functions described in the embodiments of the present disclosure are generated. The computer may be a general-purpose computer, a special-purpose computer, a computer network, or another programmable device. The computer program may be stored in a computer-readable storage medium or transmitted from one computer-readable storage medium to another. For example, the computer program may be transmitted from one website, computer, server, or data center to another website, computer, server, or data center in a wired (e.g., coaxial cable, fiber optic, or digital subscriber line (DSL)) or wireless (e.g., infrared, wireless, or microwave, or the like) manner. The computer-readable storage medium may be any available medium that is accessible by a computer, or a data storage device such as a server or data center that includes one or more available media integrated. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)), or the like.

Those of ordinary skills in the art may understand that various numerical numbers such as first, second, or the like involved in the present application are distinguished merely for the convenience of description, and are not intended to limit the scope of the embodiments of the present disclosure, but also indicate the order.

At least one in the present application may also be described as one or more, and a plurality of may be two, three, four, or more, which is not limited in the present application. In the embodiments of the present disclosure, for a technical feature, technical features in the technical feature are distinguished by “first”, “second”, “third”, “A”, “B”, “C”, and “D” and the like. There is no sequence or magnitude order among the technical features described by “first”, “second”, “third”, “A”, “B”, “C”, and “D”.

The correspondences illustrated in various tables in the present application may be configured or predefined. The values of information in various tables are merely examples and may be configured as other values, which is not limited in the present application. When correspondences between information and parameters are configured, it is not necessary that all the correspondences illustrated in various tables are configured. For example, in the tables in the present application, correspondences illustrated in certain rows may not be configured. For another example, an appropriate deformation adjustment, for example, splitting, merging, and the like may be made based on the above tables. Names of the parameters shown in headings in the above tables may also be other names understandable by the device for cell selecting. Values or representations of the parameters may also be other values or representations understandable by the device for cell selecting. The above tables may also be implemented using other data structures, for example, arrays, queues, containers, stacks, linear tables, pointers, linked lists, trees, graphs, structures, classes, heaps, hash tables or hashtables, and the like.

Predefined in the present application may be understood as defined, defined in advance, stored, pre-stored, pre-negotiated, pre-configured, solidified, or pre-fired.

Those of ordinary skills in the art may realize that units and algorithm steps of various examples described in conjunction with the embodiments disclosed herein can be implemented in electronic hardware, or a combination of computer software and electronic hardware. Whether these functions are executed in hardware or software depends on the specific application and design constraints of the technical solution. Those skilled in the art may implement the described functions for each specific application by using different methods, but such implementation is not to be considered as exceeding the scope of the present application.

Those skilled in the art can clearly understand that, for the convenience and brevity of description, for the specific working processes of the system, device, and unit described above, reference may be made to the corresponding processes in the foregoing method embodiments, which is not repeated herein.

The described are merely specific implementations of the present application, but the protection scope of the present application is not limited to this. Any modification or replacement that can be readily conceived by any person skilled in the art within the technical scope disclosed in the present application is to fall within the protection scope of the present application. Therefore, the protection scope of the present application is to be subject to the protection scope of the claims.

1. A method for cell selecting, performed by a terminal device, comprising:
determining whether the terminal device is a vehicle-mounted terminal device; and
selecting, by the terminal device, according to a result of determining whether the terminal device is a vehicle-mounted terminal device, a cell associated with an integrated access and backhaul (IAB) node.

2. The method according to claim 1, further comprising:
selecting, upon cell selection or cell reselection by the terminal device, a cell associated with a mobile IAB node as a cell with a highest priority in response to determining that the terminal device is a vehicle-mounted terminal device.

3. The method according to claim 1, wherein the mobile IAB node is:
a mobile IAB node that remains stationary relative to the terminal device.

4. The method according to claim 3, wherein
the mobile IAB node that remains stationary relative to the terminal device is a mobile IAB node belonging to the same vehicle to which the terminal device belongs.

5. The method according to claim 4, further comprising:
judging whether the mobile IAB node is a mobile IAB node that remains stationary relative to the terminal device by comparing consistency of a movement speed, a latitude and longitude position, and a movement direction of the terminal device and a movement speed, a latitude and longitude position, and a movement direction of the mobile IAB node.

6. The method according to claim 1, further comprising:
selecting, upon cell selection or cell reselection by the terminal device, a cell associated with a stationary IAB node as a cell with a lowest priority in response to determining that the terminal device is a vehicle-mounted terminal device.

7. The method according to claim 1, further comprising:
selecting, upon cell selection or cell reselection by the terminal device, a cell associated with a stationary IAB node as a cell with a highest priority in response to determining that the terminal device is a non-vehicle-mounted terminal device.

8. The method according to claim 1, further comprising:
selecting, upon cell selection or cell reselection by the terminal device, a cell associated with a mobile IAB node as a cell with a lowest priority in response to determining that the terminal device is a non-vehicle-mounted terminal device.

9. The method according to claim 1, further comprising:
triggering the terminal device to perform cell reselection, in response to determining that a mobile IAB node associated with the cell currently selected by the terminal device does not remain stationary relative to the terminal device.

10. The method according to claim 9, further comprising:
judging whether the mobile IAB node associated with the cell currently selected by the terminal device does not remain stationary relative to the terminal device, by comparing consistency of a movement speed, a latitude and longitude position, and a movement direction of the terminal device and a movement speed, a latitude and longitude position, and a movement direction of the mobile IAB node associated with the cell currently selected by the terminal device.

11. The method according to claim 1, further comprising:
triggering the terminal device to perform cell reselection, in response to determining that the terminal device has changed from the vehicle-mounted terminal device to a non-vehicle-mounted terminal device.

12. The method according to claim 7, further comprising:
triggering the terminal device to perform cell reselection, in response to determining that the terminal device has changed from the non-vehicle-mounted terminal device to a vehicle-mounted terminal device.

13. The method according to claim 1, wherein determining whether the terminal device is the vehicle-mounted terminal device
is based on movement speeds, latitude and longitude positions, and movement directions of the terminal device and a mobile IAB node.

14. The method according to claim 13, wherein determining whether the terminal device is a vehicle-mounted terminal device, according to movement speeds, latitude and longitude positions, and movement directions of the terminal device and a mobile IAB node comprises:
determining that the terminal device is a non-vehicle-mounted terminal device in a case where at least two of the movement speed, the latitude and longitude position, and the movement direction of the terminal device are inconsistent with the movement speed, the latitude and longitude position, and the movement direction of the mobile IAB node, wherein the non-vehicle-mounted terminal device is a terminal device that supports a mobile IAB feature.

15. (canceled)

16. A communication device, comprising:
a transceiver;
a memory storing computer-executable instructions; and
a processor connected to the transceiver and the memory, configured to execute the computer-executable instructions to control wireless signal transceiving of the transceiver, and when executing the computer-executable instructions comprising:
determining whether the terminal device is a vehicle-mounted terminal device, and
selecting, by the terminal device, according to a result of determining whether the terminal device is a vehicle-mounted terminal device, a cell associated with an integrated access and backhaul (IAB) node.

17. A non-temporary computer-readable storage medium, storing computer-executable instructions, wherein the computer-executable instructions, when executed by a processor, cause the processor to perform a method comprising:
determining whether the terminal device is a vehicle-mounted terminal device; and
selecting, by the terminal device, according to a result of determining whether the terminal device is a vehicle-mounted terminal device, a cell associated with an integrated access and backhaul (IAB) node.

18. The method according to claim 3, wherein the mobile IAB node that remains stationary relative to the terminal device is a mobile IAB node belonging to a vehicle different from a vehicle to which the terminal device belongs.

19. The method according to claim 8, further comprising:
triggering the terminal device to perform cell reselection, in response to determining that the terminal device has changed from the non-vehicle-mounted terminal device to a vehicle-mounted terminal device.

20. The method according to claim 13, wherein determining whether the terminal device is a vehicle-mounted terminal device, according to movement speeds, latitude and longitude positions, and movement directions of the terminal device and a mobile IAB node comprises:
determining that the terminal device is a vehicle-mounted terminal device in a case where at least two of the movement speed, the latitude and longitude position, and the movement direction of the terminal device are consistent with the movement speed, the latitude and longitude position, and the movement direction of the mobile IAB node.

21. The method according to claim 13, wherein determining whether the terminal device is a vehicle-mounted terminal device, according to movement speeds, latitude and longitude positions, and movement directions of the terminal device and a mobile IAB node comprises:
determining that the terminal device is a non-vehicle-mounted terminal device in a case where at least two of the movement speed, the latitude and longitude position, and the movement direction of the terminal device are inconsistent with the movement speed, the latitude and longitude position, and the movement direction of the mobile IAB node.
